(19) United States
(12) Patent Application Publication
(10) Pub. No.: US 2023/0409897 A1
(43) Pub. Date: Dec. 21, 2023

(54) SYSTEMS AND METHODS FOR CLASSIFYING MUSIC FROM HETEROGENOUS AUDIO SOURCES

(71) Applicant: Netflix, Inc., Los Gatos, CA (US)

(72) Inventors: Yadong Wang, Campbell, CA (US); Jeff Kitchener, Los Gatos, CA (US); Shilpa Jois Rao, Cupertino, CA (US)

(21) Appl. No.: 17/841,322

(22) Filed: Jun. 15, 2022

(51) Int. Cl. G06N 3/08; G10H 1/00

(52) U.S. Cl. CPC G06N 3/08; G10H 1/0008; G10H 2250/311; G10H 2210/036; G10H 2210/041

(57) ABSTRACT

The disclosed computer-implemented method may include accessing an audio stream with heterogenous audio content; dividing the audio stream into a plurality of frames; generating a plurality of spectrogram patches, each spectrogram patch within the plurality of spectrogram patches being derived from a frame within the plurality of frames; and providing each spectrogram patch within the plurality of spectrogram patches as input to a convolutional neural network classifier and receiving, as output, a classification of music within a corresponding frame from within the plurality of frames. Various other methods, systems, and computer-readable media are also disclosed.

### BACKGROUND

In the digital age, there is an ever-growing corpus of data that can be difficult to sort through. For example, countless hours of digital multimedia are being created and stored every day, but the content of this multimedia may be largely unknown. Even where multimedia content is partly described by metadata, the content may be heterogenous and complex, and some aspects of the content may remain opaque. For example, music that is a part of, but not necessarily the principal subject of, multimedia content (e.g., film or television show soundtracks) may not be fully accounted for—including by those who manage, own, or have other rights over such content.

### SUMMARY

As will be described in greater detail below, the present disclosure describes systems and methods for classifying music from heterogenous audio sources.

In one example, a computer-implemented method for classifying music from heterogenous audio sources may include accessing an audio stream with heterogenous audio content. The method may also include dividing the audio stream into a plurality of frames. The method may further include generating a plurality of spectrogram patches, each spectrogram patch within the plurality of spectrogram patches being derived from a frame within the plurality of frames. In addition, the method may include providing each spectrogram patch within the plurality of spectrogram patches as input to a convolutional neural network classifier and receiving, as output, a classification of music within a corresponding frame from within the plurality of frames.

In some examples, the classification of music may include a classification of a musical mood. Additionally or alternatively, the classification of music may include a classification of a musical genre, a musical style, and/or a musical tempo.

In the above example or other examples, the plurality of spectrogram patches may include a plurality of mel spectrogram patches. In this or other examples, the plurality of spectrogram patches may include a plurality of log-scaled mel spectrogram patches.

Furthermore, in the above or other examples, the computer-implemented method may also include identifying, across a plurality of frames, a subset of consecutive frames with a common classification; and applying the common classification as a label to an integral segment of music comprising the subset of consecutive frames. In this or other examples, identifying the subset of consecutive frames may include applying a temporal smoothing function to classifications corresponding to the plurality of frames. Additionally or alternatively, in the above or other examples, the computer-implemented method may include recording, in a data store, the audio stream as containing music with the common classification; and recording, in the data store, at least one timestamp of indicating a location of the subset of consecutive frames.

Furthermore, in the above or other examples, the computer-implemented method may include identifying at least one additional segment of music adjacent to the subset of consecutive frames with a different classification from the common classification; and applying the common classification and the different classification as labels to a larger segment of music comprising the integral segment of music and the additional segment(s) of music.

Moreover, in the above or other example, the computer-implemented method may include identifying a corpus of frames having predetermined music-based classifications; and training the convolutional neural network classifier with the corpus of frames and the predetermined music-based classifications.

In addition, a corresponding system for classifying music from heterogenous audio sources may include at least one physical processor and physical memory including computer-executable instructions that, when executed by the physical processor, cause the physical processor to perform operations including (1) accessing an audio stream with heterogenous audio content, (2) generating a plurality of spectrogram patches, each spectrogram patch within the plurality of spectrogram patches being derived from a frame within the plurality of frames, (3) providing each spectrogram patch within the plurality of spectrogram patches as input to a convolutional neural network classifier and (4) receiving, as output, a classification of music within a corresponding frame from within the plurality of frames.

In some examples, the above-described method may be encoded as computer-readable instructions on a computer-readable medium. For example, a computer-readable medium may include one or more computer-executable instructions that, when executed by at least one processor of a computing device, may cause the computing device to (1) access an audio stream with heterogenous audio content, (2) generate a plurality of spectrogram patches, each spectrogram patch within the plurality of spectrogram patches being derived from a frame within the plurality of frames, (3) provide each spectrogram patch within the plurality of spectrogram patches as input to a convolutional neural network classifier and (4) receive, as output, a classification of music within a corresponding frame from within the plurality of frames.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a diagram of an example system for classifying music from heterogenous audio sources.

FIG. 2 is a flow diagram for an example method for classifying music from heterogenous audio sources.

FIG. 3 is an illustration of an example heterogenous audio stream.

FIG. 4 is an illustration of an example division of the heterogenous audio stream of FIG. 3.

FIG. 5 is an illustration of example spectrogram patches generated from segments of the heterogenous audio stream of FIG. 3.

FIG. 6 is a diagram of an example convolutional neural network for classifying music from heterogenous audio sources.

FIG. 7 is an illustration of example classifications of the heterogenous audio stream of FIG. 3.

FIG. 8 is an illustration of example classifications of the heterogenous audio stream of FIG. 3.

Throughout the drawings, identical reference characters and descriptions indicate similar, but not necessarily identical, elements. While the exemplary embodiments described herein are susceptible to various modifications and alternative forms, specific embodiments have been shown byway of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to classifying music from heterogenous audio sources. Audio tracks with heterogeneous content (e.g., television show or film soundtracks) may include music. As will be discussed in greater detail herein, a machine learning model may tag music in audio sources according to the music's features. For example, sliding windows of audio may be used as input (formatted, e.g., as mel-spaced frequency bins) for a convolutional neural network in training and classification. The model may be trained to identify and classify stretches of music by mood (e.g., ‘happy’, ‘funny’, ‘sad’, ‘scary’, etc.), genre, instrumentation, tempo, etc. In some examples, a searchable library of soundtrack music may thereby be generated, such that stretches of music with a specified combination of features (and, e.g., a duration range) can be identified.

By identifying and classifying music in heterogeneous audio sources, the systems and methods described herein may generate an index of music searchable by attributes (such as mood). Thus, these systems and methods improve the functioning of a computer by enhancing storage capabilities of a computer to identify music (by mood, etc.) within stored audio. Furthermore, these systems and methods improve the functioning of a computer by providing improved machine learning models for analyzing audio streams and classifying music. In addition, these systems and methods may improve the fields of computer storage, computer searching, and machine learning.

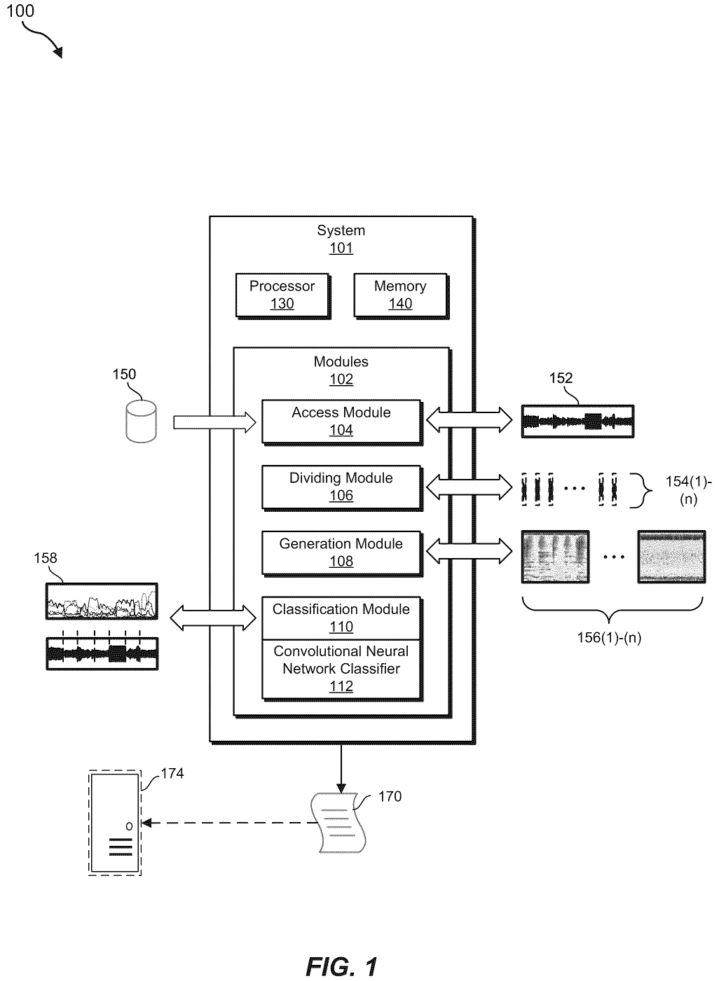

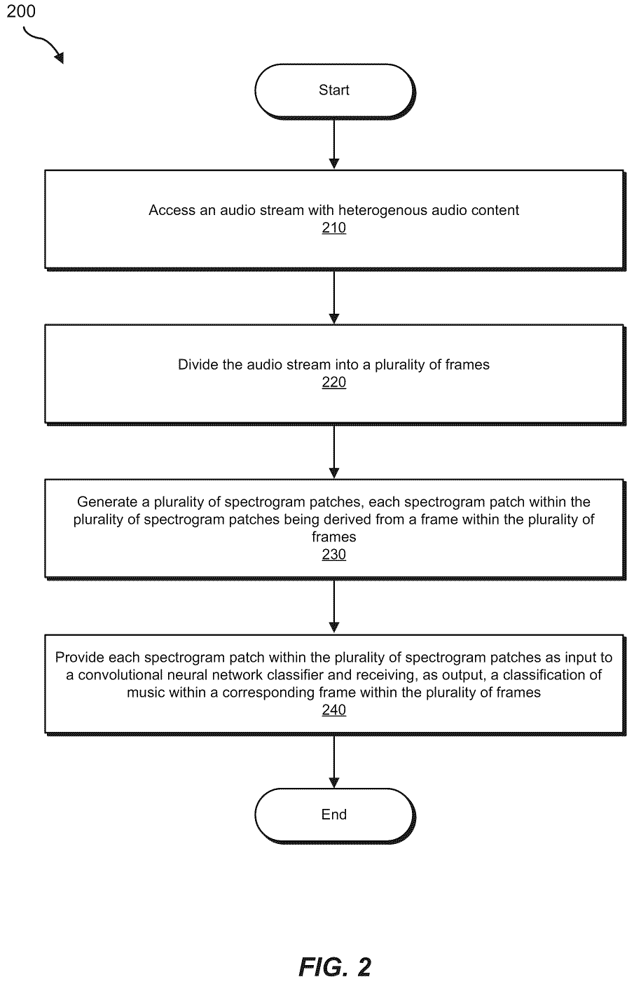

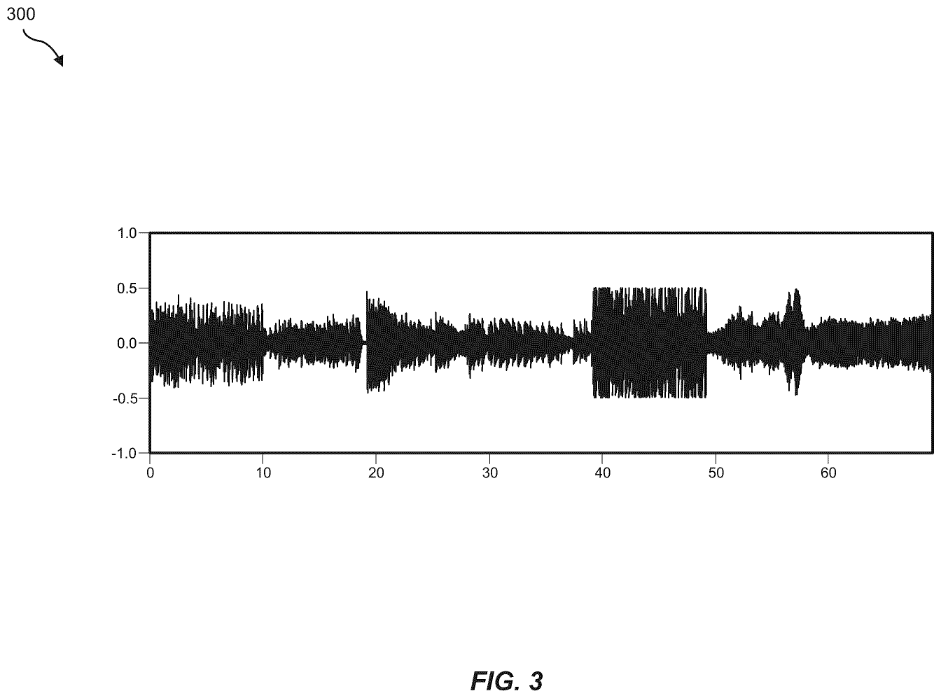

The following will provide, with reference to FIG. 1, detailed descriptions of an example system for classifying music from heterogenous audio sources; with reference to FIG. 2, detailed descriptions of an example method for classifying music from heterogenous audio sources; and, with reference to FIGS. 3-8, detailed descriptions of an example of classifying music from heterogenous audio sources.

FIG. 1 illustrates a computing environment 100 that includes a computer system 101. The computer system 101 includes software modules, embedded hardware components such as processors, or a combination of hardware and software. The computer system 101 is substantially any type of computing system including a local computing system or a distributed (e.g., cloud) computing system. In some cases, the computer system 101 includes at least one processor 130 and at least some system memory 140. The computer system 101 includes program modules 102 for performing a variety of different functions. The program modules are hardware-based, software-based, or include a combination of hardware and software. Each program module uses computing hardware and/or software to perform specified functions, including those described herein below.

System 101 may include an access module 104 that is configured to access an audio stream with heterogenous audio content. Access module 104 may access the audio stream in any suitable manner. For example, access module 104 may identify a data object 150 (e.g., a video) and decode the audio from data object 150 to access an audio stream 152. By way of example, access module 104 may access audio stream 150.

System 101 may also include a dividing module 106 that is configured to divide the audio stream into frames. By way of example, dividing module 106 may divide audio stream 152 into frames 154(1)-(n).

System 101 may further include a generation module 108 that is configured to generate spectrogram patches, where each spectrogram patch is derived from a frame from the audio stream. By way of example, generation module 108 may generate spectrogram patches 156(1)-(n) from frames 154(1)-(n).

System 101 may additionally include a classification module 110 configured to provide each spectrogram patch as input to a convolutional neural network classifier and receive, as output, a classification of music within a corresponding frame. Thus, the convolutional neural network classifier may classify each spectrogram patch and, thereby, classify each frame corresponding to that patch. By way of example, classification module 101 may provide each of spectrogram patches 156(1)-(n) to a convolutional neural network classifier 112 and receive a classification of music corresponding to each of frames 154(1)-(n). In some examples, these classifications may be aggregated (e.g., to form a classification of audio stream 152 and/or a portion of audio stream 152), such as in a classification 158 of audio stream 152.

In some examples, systems described herein may provide classification information about the audio stream to a searchable index. For example, system 101 may generate metadata 170 describing music found in audio stream 152 (e.g., timestamps in audio stream 152 where music with specified moods are found) and add metadata 170 to a searchable index 174, where metadata 170 may be associated with audio stream 152 and/or data object 150.

FIG. 2 is a flow diagram for an example computer-implemented method 200 for classifying music from heterogenous audio sources. The steps shown in FIG. 2 may be performed by any suitable computer-executable code and/or computing system, including the system(s) illustrated in FIG. 1. In one example, each of the steps shown in FIG. 2 may represent an algorithm whose structure includes and/or is represented by multiple sub-steps, examples of which will be provided in greater detail below.

As illustrated in FIG. 2, at step 210 one or more of the systems described herein may access an audio stream with heterogenous audio content. As used herein, the term “audio stream” may refer to any digital representation of audio. The audio stream may include and/or be derived from any suitable form, including one or more files within a file system, one or more database objects within a database, etc. In some examples, the audio stream may be a standalone media object. In some examples, the audio stream may be a part of a more complex data object, such as a video. For example, the audio stream may include a film and/or television show soundtrack.

The systems described herein may access the audio stream in any suitable context. For example, these systems may receive the audio stream as input by an end user, from a configuration file, and/or from another system. Additionally or alternatively, these systems may receive a list of audio streams (and/or storage locations including audio streams) as input by an end user, from a configuration file, and/or from another system. In some examples, these systems may analyze the audio stream (and/or a storage container of the audio stream) and determine, based on the analysis, that the audio stream is subject to the methods described herein. Additionally or alternatively, these systems may identify metadata that indicates that the audio stream is subject to the methods described herein. In one example, the audio stream may be a part of a library of media designated for indexing. For example, the systems described herein may analyze a library of media and return a searchable index of music found in the media.

As used herein, the term “heterogenous audio content” may refer to any content where attributes of the audio content are not prespecified. In some examples, heterogenous audio content may include audio content that is unknown (e.g., to the systems described herein and/or to one or more operators of the systems described herein). For example, it may be unknown whether the audio content includes music. In some examples, heterogenous audio content may include audio content that includes (or may include) both music and non-music (e.g., vocal, environmental sounds, etc.) audio content. In some examples, heterogenous audio content may include music that is abbreviated (e.g., includes some portions of a music track but not the complete music track) and/or partly obscured by other audio. In some examples, heterogenous audio content may include audio content that includes (or may include) multiple separate instances of music. In some examples, heterogenous audio content may include audio content that includes music with unspecified and/or ambiguous start and/or end times.

Thus, it may be appreciated that the systems described herein may take, as initial input, an audio stream without parameters about any music to be found in the input being prespecified or assumed. As an example, a film soundtrack may include various samples of music (whether, e.g., diegetic music, incidental music, or underscored music) as well as dialogue, environmental sounds, and/or other sound effects. The nature or location of the music within the soundtrack may not be known prior to analysis (e.g., by the systems described herein).

FIG. 3 is an illustration of an example heterogenous audio stream 300. As shown in FIG. 3. In one example, audio stream 300 may include several samples of music. Additionally or alternatively, audio stream 300 may represent a single piece of music with changing attributes over time. In some examples, audio stream 300 may include only music; nevertheless, audio stream 300 may not be known or assumed to include only music, and the presence and/or location of music within audio stream 300 may be unknown, unassumed, and/or unspecified. In other examples, audio stream 300 may include other audio besides music (e.g., dialogue, environmental sounds, etc.) intermixed with the music.

Returning to FIG. 2, at step 220 one or more of the systems described herein may divide the audio stream into a set of frames. As used herein, the term “frame” as it applies to audio streams may refer to any segment, portion, and/or window of an audio stream. In some examples, a frame may be an uninterrupted segment of an audio stream. In addition, in some examples the systems described herein may divide the audio stream into frames of equal length (e.g., in terms of time). For example, these systems may divide the audio stream into frames of a predetermined length of time. (As will be described in greater detail below, the predetermined length of time may correspond to a length of time used for frames used when training a machine learning model.) In these examples, the audio stream may not divide perfectly evenly—i.e., there may be a remainder of audio shorter than the length of a single frame. To correct for this, in one example, the systems and methods described herein may add a buffer (e.g., to the start of the first frame or to the end of the final frame) to result in a set of frames of equal length.

Furthermore, in various examples, the systems described herein may divide the audio stream into non-overlapping frames. Additionally, in some examples, the systems described herein may divide the audio stream into consecutive frames (e.g., not leaving gaps between frames).

The systems described herein may use any suitable length of time for the frame length. Examples ranges of frame lengths include, without limitation, 900 milliseconds to 1100 milliseconds, 800 milliseconds to 1200 milliseconds, 500 milliseconds to 1500 milliseconds, 500 milliseconds to 1000 milliseconds, and 900 milliseconds to 1500 milliseconds.

In dividing the frames, in some examples the systems described herein may associate the frames with their position and/or ordering within the audio stream. For example, the systems described herein may index and/or number the frames according to their order in the audio stream. Additionally or alternatively, the systems described herein may create a timestamp for each frame and associate the timestamp with the frame.

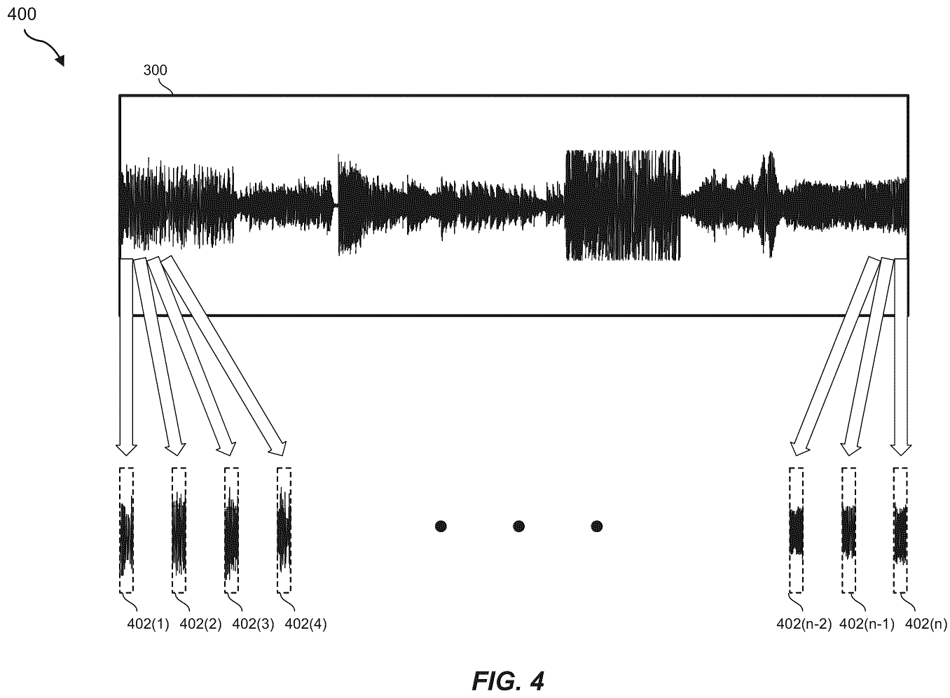

FIG. 4 is an illustration of an example division 400 of the heterogenous audio stream of FIG. 3. As shown in FIG. 4, the systems described herein may divide heterogenous audio stream 300 into frames 402(1)-(n). As shown in FIG. 4, in one example frames 401(1)-(n) may be non-overlapping, consecutive and adjacent, and of equal length.

Returning to FIG. 2, at step 230 one or more of the systems described herein may generate a set of spectrogram patches, each spectrogram patch being derived from a corresponding frame from the set of frames. As used herein, the term “spectrogram” as it relates to audio data may refer to any representation of an audio signal over time (e.g., by frequency and/or strength). The term “spectrogram patch,” as used here, may refer to any spectrogram data discretized by time and by frequency. For example, systems described herein may transform spectrogram data to an array of discrete spectral bins, where each spectral bin corresponds to a time window and a frequency range and represents a signal strength within that time window and frequency range.

The systems described herein may generate the spectrogram patches in any suitable manner. For example, for each frame, these systems may decompose the frame with a short-time Fourier transform. In one example, these systems may apply the short-time Fourier transform using a series of time windows (e.g., each window being the length of time covered by a spectral bin). In some examples, these time windows may be overlapping. Thus, for example, if each frame is 960 milliseconds, the systems described herein may decompose a frame with a Fourier transform that applies 25 millisecond windows every 10 milliseconds, resulting in 96 discrete windows of time representing the frame.

As described above, the systems described herein may divide the spectral information into spectral bins both by time and by frequency. These systems may divide the spectral information into any suitable frequency bands. For example, these systems may divide the spectral information into mel-spaced frequency bands (e.g., frequency bands of equal size when using a mel scale rather than a linear scale of hertz). As used herein, the term “mel scale” may refer to any scale that is logarithmic with respect to hertz. Accordingly, “mel-spaced” may refer to equal divisions according to a mel scale. Likewise, a “mel spectrogram patch” may refer to a spectrogram patch with mel-spaced frequency bands.

In some examples, the mel scale may correspond to a perceptual scale of frequencies, where distance in the mel scale correlates with human perception of difference in frequency. The systems and methods described herein may, in this sense, use any known and/or recognized mel scale, and/or a substantial approximation thereof. In one example, these systems and methods may use a mel scale represented by m=2595*log₁₀(1+f/700), where f represents a frequency in hertz and m represents frequency in the mel scale. In another example, these systems and methods may use a mel scale represented by m=2410*log₁₀(1+f/625). By way of other examples, these systems and methods may use a mel scale approximately representable by m=x*log₁₀(1+f/y). Examples of values of x that may be used in the foregoing example include, without limitation, values in a range of 2400 to 2600, 2300 to 2700, 2200 to 2800, 2100 to 2900, 2000 to 3000, and 1500 to 5000. Examples of values of y that may be used in the foregoing example include, without limitation, values in a range of 600 to 750, 550 to 800, and 500 to 850. It may be appreciated that a mel scale may be expressed in various different terms and/or formulations. Accordingly, the foregoing examples of functions also provide example lower and upper bounds. Substantially monotonic functions that substantially fall within the bounds of any two functions disclosed herein also provide examples of functions expressing a mel scale that may be used by systems and methods described herein.

As can be appreciated, by dividing the length of time of frame into smaller time steps and by dividing the frequencies of the frame into smaller frequency bands, the systems and methods described herein may create an array of spectral bins (frequency by time). These systems may associate each spectral bin with a signal strength for the frequency band of that bin over the time window of that bin.

In some examples, the systems and methods described herein may log-scale the value (e.g., signal strength) of each bin (e.g., apply a logarithmic function to the value). As used herein, the term “log-scaled mel spectrogram patch” may generally refer to any mel spectrogram patch where the values of each bin has been log-scaled. In some examples, log-scaling the values of the bins may also include adding an offset value before applying the logarithmic function. In some examples, the offset value may be a small and/or minimal offset value (e.g., to avoid an undefined result for log(x) where x is 0, or a negative result where x is greater than 0 but less than 1). For example, the offset value may be greater than 0 and less than or equal to 1.

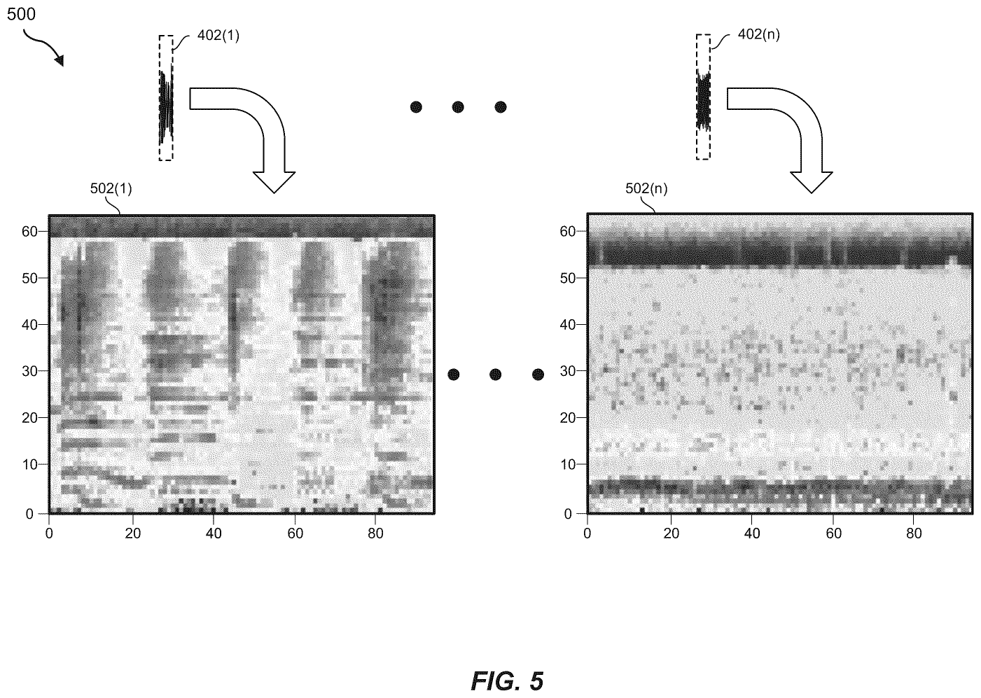

FIG. 5 is an illustration of an example generation 500 of spectrograms from frames of the heterogenous audio stream of FIG. 3. As shown in FIG. 5, systems described herein may generate spectrogram patches 502(1)-(n) from frames 402(1)-(n), respectively. Thus, for example, spectrogram patch 502(1) may represent frame 402(1), and so on. By way of example, the spectrogram patches illustrated in FIG. 5 have 64 frequency steps and 96 time steps, resulting in 6,144 discrete spectral bins. However, in other examples the spectrogram patches may be of different sizes. Examples of the number of frequency steps that systems described herein may use in spectrogram patches include, without limitation, values in the ranges of 60 to 70, 50 to 80, 40 to 90, 30 to 100, 50 to 100, and 30 to 80. Examples of the number of time steps that systems described herein may use in spectrogram patches include, without limitation, values in the ranges of 90 to 110, 80 to 120, 50 to 150, 50 to 100, and 90 to 150.

Returning to FIG. 2, at step 240 one or more of the systems described herein may provide each generated spectrogram patch as input (e.g., one spectrogram patch at a time) to a convolutional neural network classifier and receive, as output, a classification of music within the corresponding frame.

As mentioned earlier, in some examples heterogenous audio content may include both music and non-music audio. Systems described herein may handle non-music audio portions of heterogenous audio content in any of a variety of ways. In some examples, the convolutional neural network classifier may be trained to, among other things, classify each spectrogram patch as ‘music’ or not (as opposed to, e.g., alternatives such as ‘speech’ and/or various types of environmental sounds). Thus, for example, the classification of music that is output by the convolutional neural network classifier may include a classification of whether each given spectrogram patch represents and/or contains music. Additionally or alternatively, the systems described herein may regard as non-music any spectrogram patch that is not classified with any particular musical attributes (e.g., that is not classified with any musical moods, musical styles, etc., above a predetermined probability threshold).

In addition to or instead of distinguishing between music and non-music audio via the convolutional neural network classifier, in some examples, one or more systems described herein (and/or one or more systems external to the systems described herein) may perform a first pass on the heterogenous audio content to identify portions of the heterogenous audio content that contain music. Thus, for example, a music/non-music classifier (e.g., a convolutional neural network or other suitable classifier) may be trained to distinguish between music and other audio (e.g., speech). Accordingly, systems described herein may use output from the music/non-music classifier to determine which spectrogram patches to provide as input to the convolutional neural network to further classify by particular musical attributes. In general, the systems described herein may use any suitable method for distinguishing between music and non-music audio.

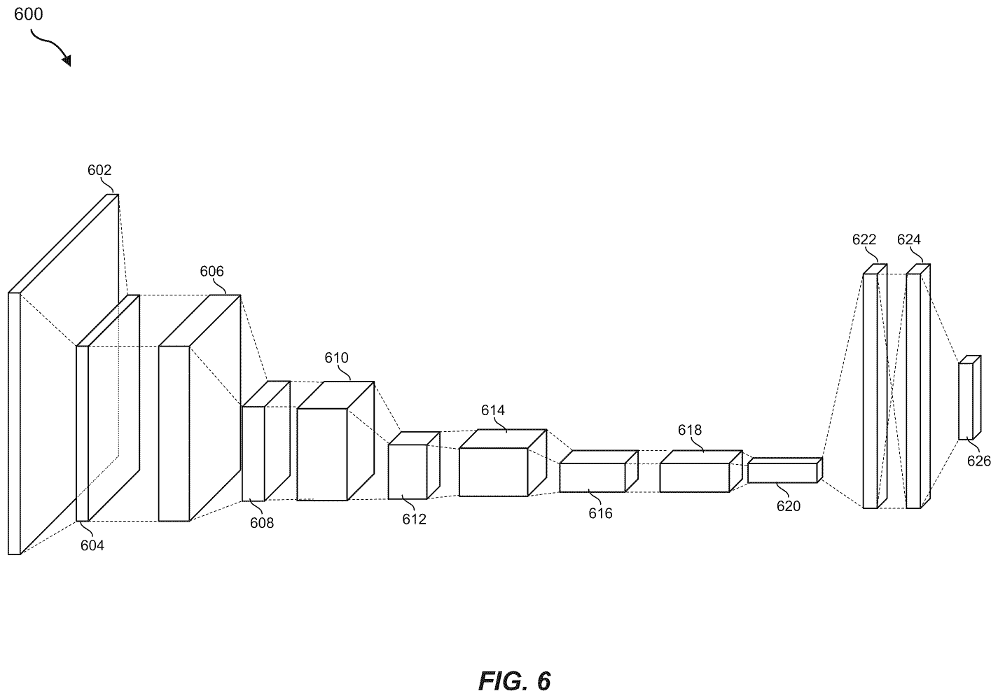

The convolutional neural network may have any suitable architecture. By way of example, FIG. 6 is a diagram of an example convolutional neural network 600 for classifying music from heterogenous audio sources. As shown in FIG. 6, convolutional neural network 600 may include a convolutional block 602 with one or more convolutional layers. For example, the block 602 may include two convolutional layers. Convolutional neural network 600 may also include a pooling layer 604. For example, pooling layer 604 may downsample from block 602, e.g., with a max pooling operation. Convolutional neural network 600 may also include a convolutional block 606 with one or more convolutional layers. For example, the block 606 may include two convolutional layers. Convolutional neural network 600 may also include a pooling layer 608. For example, pooling layer 608 may downsample from block 606, e.g., with a max pooling operation. Convolutional neural network 600 may also include a convolutional block 610 with one or more convolutional layers. For example, the block 610 may include four convolutional layers. Convolutional neural network 600 may also include a pooling layer 612. For example, pooling layer 612 may downsample from block 610, e.g., with a max pooling operation.

Convolutional neural network 600 may also include a convolutional block 614 with one or more convolutional layers. For example, the block 614 may include four convolutional layers. Convolutional neural network 600 may also include a pooling layer 616. For example, pooling layer 616 may downsample from block 614, e.g., with a max pooling operation. Convolutional neural network 600 may also include a convolutional block 618 with one or more convolutional layers. For example, the block 618 may include four convolutional layers. Convolutional neural network 600 may also include a pooling layer 620. For example, pooling layer 620 may downsample from block 618, e.g., with a max pooling operation.

The convolutional layers may use any appropriate filter. For example, the convolutional layers of blocks 602, 606, 610, 614, and 618 may use 3×3 convolution filters. The convolutional layers may have any appropriate depth. For example, the convolutional layers of blocks 602, 606, 610, 614, and 618 may have depths of 64, 128, 256, 512, and 512, respectively.

In some examples, convolutional neural network 600 may have fewer convolutional layers. For example, convolutional neural network 600 may be without block 618 (and pooling layer 620). In some examples, convolutional neural network 600 may also be without block 614 (and pooling layer 620). Additionally, in some examples, convolutional neural network may be without block 610 (and pooling layer 612).

Convolutional neural network 600 may also include a fully connected layer 622 and a fully connected layer 624. In one example, the size of fully connected layers 622 and 624 may be 4096. In another example, the size may be 512. Convolutional neural network 600 may additionally include a final sigmoid layer 626.

In some examples, the systems and methods described herein may train the convolutional neural network (e.g., convolutional neural network 600). These systems may perform training with any suitable loss function. For example, these systems may use a cross-entropy loss function. In some examples, the systems described herein may train the convolutional neural network using a corpus of frames that already have music-based classifications. For example, the corpus may include frames already divided into the predetermined length to be used by the convolutional neural network and already labeled with the categories to be used by the convolutional neural network. Additionally or alternatively, the systems described herein may generate at least a part of the corpus by scraping one or more data sources (e.g., the internet) for audio samples that are associated with metadata and/or natural language descriptions. These systems may then map the metadata and/or natural language descriptions onto standard categories to be used by the convolutional neural network (and/or may create categories to be used by the convolutional neural network based on hidden semantic themes identified by, e.g., natural language processing). These systems may then divide the audio samples into frames and train the convolutional neural network with the frames and the inferred categories.

The classification of music generated by convolutional neural network 600 may include any suitable type of classification. For example, the classification of music may include a classification of a musical mood of the spectrogram patch (and, thus, the corresponding frame). As used herein, the term ‘musical mood’ may refer to any characterization of music linked with an emotion (as expressed and/or as evoked), a disposition, and/or an atmosphere (e.g., a setting of cognitive and/or emotional import). Examples of musical moods include, without limitation, ‘happy,’ ‘funny,’ ‘sad,’ ‘tender,’ ‘exciting,’ ‘angry,’ and ‘scary.’ In some examples, the convolutional neural network may classify across a large number of potential moods (e.g., dozens or hundreds). For example, the convolutional neural network may be trained to classify frames with a musical mood of ‘accusatory,’ ‘aggressive,’ ‘anxious,’ ‘bold,’ ‘brooding,’ ‘cautious,’ ‘dejected,’ ‘earnest,’ ‘fanciful,’ etc. In one example, the convolutional neural network may output a vector of probabilities, each probability corresponding to a potential classification.

In some examples, the classification of music generated by convolutional neural network 600 may include musical genres. Examples of musical genres include, without limitation, ‘acid jazz,’ ‘ambient,’ ‘hip hop,’ ‘nu-disco,’ ‘rock,’ etc. Additionally or alternatively, the classification of music generated by convolutional neural network 600 may include musical tempo (e.g., in terms of beats per minute). In some examples, the classification of music generated by convolutional neural network 600 may include musical styles. As used herein, the term “musical style” may refer to a classification of music by similarity to an artist or other media. Examples of musical styles include, without limitation, musicians, musical groups, composers, musical albums, films, television shows, and video games.

After classifying each frame, in some examples the systems and methods described herein may apply classifications across several frames. For example, these systems may determine that a consecutive series of frames have a common classification and then label that portion of the audio stream with the classification. Thus, for example, if all frames from the 320 second mark to the 410 second mark are classified as ‘happy,’ then the systems described herein may designate a 90-second stretch of happy music starting at the 320 second mark.

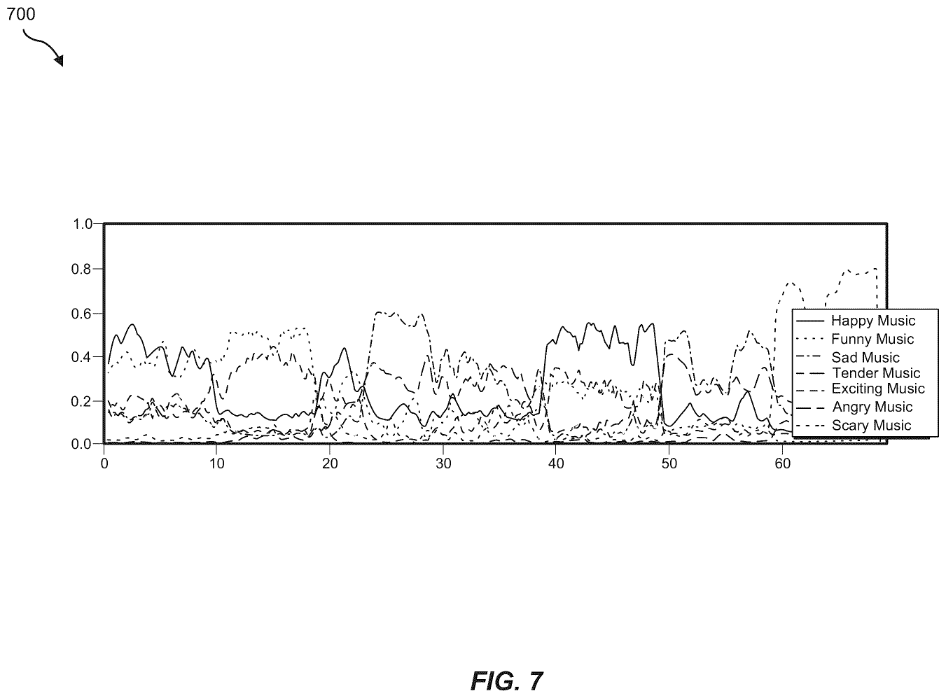

FIG. 7 is an illustration of example classifications 700 of the heterogenous audio stream of FIG. 3. As shown in FIG. 7, classifications 700 may show the probabilities assigned by the convolutional neural network to each musical mood for each frame. In addition, classifications 700 may show that particular musical mood classifications appear continuously over stretches of time (i.e., across consecutive frames).

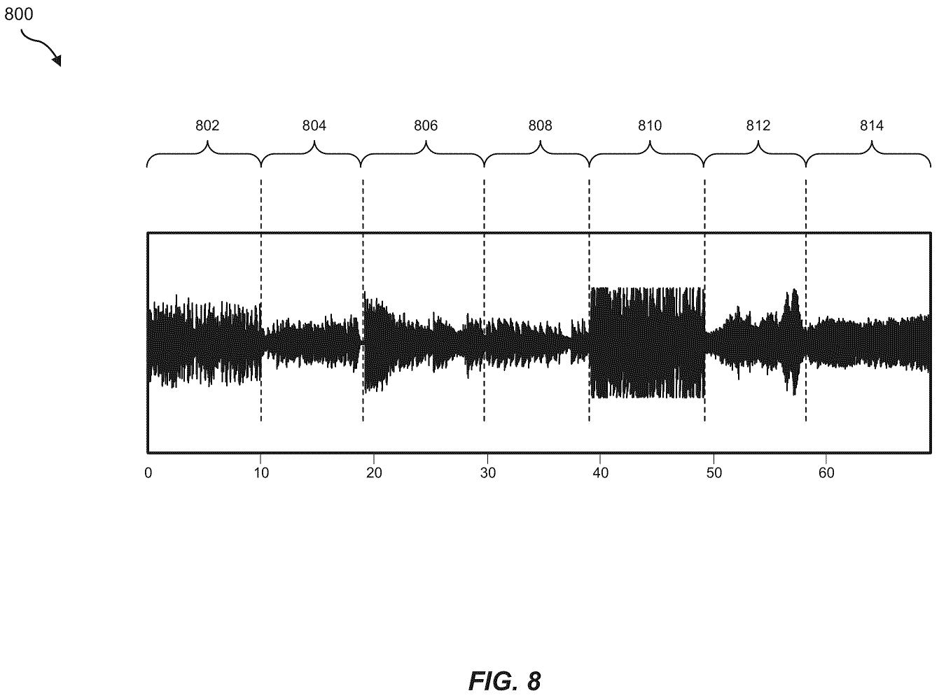

FIG. 8 is an illustration of example classifications applied to heterogenous audio stream 300 of FIG. 3, reflecting the classifications 700 of FIG. 7. As shown in FIG. 8, systems described herein may tag a portion 802 of stream 300 (e.g., as ‘happy’ music). Likewise, portions 804, 806, 808, 810, 812, and 814 may be tagged as ‘funny,’ ‘sad,’ ‘tender,’ ‘happy,’ ‘sad,’ and ‘scary,’ respectively. In some examples, the systems described herein may apply a temporal smoothing function to the initial raw classifications of the individual frames. For example, turning back to FIG. 7, during the first 10 seconds the classifications may mostly indicate ‘happy music,’ but one or two frames may show a slight preference to the classification of ‘funny music.’ Nevertheless, the systems described herein may smooth the estimations of ‘happy music’ and/or of ‘funny music’ over time resulting in a consistent evaluation of ‘happy music’ for the entire segment.

As can be appreciated from FIGS. 7, in some examples multiple musical classifications may evidence strong probabilities over the same period of time. For example, with reference to FIGS. 7 and 8, classification 700 may show, during portion 802, high probabilities of ‘happy music’ and ‘funny music,’ such that systems described herein may apply both tags to portion 802. Similarly, these systems may tag portion 804 as both ‘funny music’ and ‘exciting music.’ In some examples, the systems described herein may apply a tag based at least in part on the probability of a classification exceeding a predetermined threshold (e.g., 50 percent probability).

As mentioned earlier, in some examples the systems and methods described herein may build a searchable index of music from analyzing one or more audio streams. Thus, these systems may populate the searchable index with entries indicating one or more of: (1) the source audio stream where the music was found, (2) the location (timestamp) within the source audio stream where the music was found, (3) the length of the music, (4) one or more tags/classifications applied to the music (e.g., moods, genres, styles, tempo, etc.), and/or (5) context in which the music was found (e.g., referring to attributes of surrounding music and/or to other metadata describing the audio stream including, e.g., video content, other types of audio (speech, environmental sounds), other aspects of the music (e.g., lyrics) and/or subtitle content. Thus, an operator may enter a search for a type of music with one or more parameters (e.g., ‘happy and not funny music, longer than 30 seconds’; ‘scary music, more than 90 beats per minute’; or ‘uptempo, happy, lyric theme of love’) and systems described herein may return, in response, a list of music meeting the criteria, including the source audio stream where the music is located, the timestamp, and/or the list of classifications.

In some examples, the systems described herein may identify a consecutive stretch of audio with consistent musical classifications as an isolated musical object (e.g., starting and ending with the consistent classifications). Additionally or alternatively, these systems may identify a consecutive stretch of audio identified as music but with varying musical classifications as an integral musical object. Thus, for example, these systems may index a portion of music with consistent musical classifications on its own and also as a part of a larger portion of music with varying classifications.

As described above, the systems and methods described herein may be used to create a robust and centralized music library index that may allow operators to deeply search a catalog of music based on one or more attributes. In one example, a media owner with a large catalog of media that includes embedded music may use such a music library index to quickly find (and, e.g., reuse or repurpose) music of specified attributes.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive multimedia data to be transformed, transform the multimedia data, output a result of the transformation to generate a searchable index of music, use the result of the transformation to result search results for music embedded in multimedia content meeting specified attributes, and store the result of the transformation to a storage device. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
accessing an audio stream with heterogenous audio content;
dividing the audio stream into a plurality of frames;
generating a plurality of spectrogram patches, each spectrogram patch within the plurality of spectrogram patches being derived from a frame within the plurality of frames; and
providing each spectrogram patch within the plurality of spectrogram patches as input to a convolutional neural network classifier and receiving, as output, a classification of music within a corresponding frame from within the plurality of frames.

2. The computer-implemented method of claim 1, wherein the classification of music comprises a classification of a musical mood.

3. The computer-implemented method of claim 1, wherein the classification of music comprises a classification of at least one of:
a musical genre;
a musical style; or
a musical tempo.

4. The computer-implemented method of claim 1, wherein the plurality of spectrogram patches comprises a plurality of mel spectrogram patches.

5. The computer-implemented method of claim 4, wherein the plurality of spectrogram patches comprises a plurality of log-scaled mel spectrogram patches.

6. The computer-implemented method of claim 1, further comprising:
identifying, across a plurality of frames, a subset of consecutive frames with a common classification; and
applying the common classification as a label to an integral segment of music comprising the subset of consecutive frames.

7. The computer-implemented method of claim 6, wherein identifying the subset of consecutive frames comprises applying a temporal smoothing function to classifications corresponding to the plurality of frames.

8. The computer-implemented method of claim 6:
recording, in a data store, the audio stream as containing music with the common classification; and
recording, in the data store, at least one timestamp of indicating a location of the subset of consecutive frames.

9. The computer-implemented method of claim 6, further comprising:
identifying at least one additional segment of music adjacent to the subset of consecutive frames with a different classification from the common classification; and
applying the common classification and the different classification as labels to a larger segment of music comprising the integral segment of music and the at least one additional segment of music.

10. The computer-implemented method of claim 1, further comprising:
identifying a corpus of frames having predetermined music-based classifications; and
training the convolutional neural network classifier with the corpus of frames and the predetermined music-based classifications.

11. A system comprising:
at least one physical processor;
physical memory comprising computer-executable instructions that, when executed by the physical processor, cause the physical processor to:
access an audio stream with heterogenous audio content;
divide the audio stream into a plurality of frames;
generate a plurality of spectrogram patches, each spectrogram patch within the plurality of spectrogram patches being derived from a frame within the plurality of frames; and
provide each spectrogram patch within the plurality of spectrogram patches as input to a convolutional neural network classifier and receiving, as output, a classification of music within a corresponding frame from within the plurality of frames.

12. The system of claim 11, wherein the classification of music comprises a classification of a musical mood.

13. The system of claim 11, wherein the classification of music comprises a classification of at least one of:
a musical genre;
a musical style; or
a musical tempo.

14. The system of claim 11, wherein the plurality of spectrogram patches comprises a plurality of mel spectrogram patches.

15. The system of claim 14, wherein the plurality of spectrogram patches comprises a plurality of log-scaled mel spectrogram patches.

16. The system of claim 11, further comprising:
identifying, across a plurality of frames, a subset of consecutive frames with a common classification; and
applying the common classification as a label to an integral segment of music comprising the subset of consecutive frames.

17. The system of claim 16, wherein identifying the subset of consecutive frames comprises applying a temporal smoothing function to classifications corresponding to the plurality of frames.

18. The system of claim 16:
recording, in a data store, the audio stream as containing music with the common classification; and
recording, in the data store, at least one timestamp of indicating a location of the subset of consecutive frames.

19. The system of claim 16, further comprising:
identifying at least one additional segment of music adjacent to the subset of consecutive frames with a different classification from the common classification; and
applying the common classification and the different classification as labels to a larger segment of music comprising the integral segment of music and the at least one additional segment of music.

20. A non-transitory computer-readable medium comprising one or more computer-executable instructions that, when executed by at least one processor of a computing device, cause the computing device to:
access an audio stream with heterogenous audio content;
divide the audio stream into a plurality of frames;
generate a plurality of spectrogram patches, each spectrogram patch within the plurality of spectrogram patches being derived from a frame within the plurality of frames; and
provide each spectrogram patch within the plurality of spectrogram patches as input to a convolutional neural network classifier and receiving, as output, a classification of music within a corresponding frame from within the plurality of frames.
